(19) United States
(12) Patent Application Publication
(10) Pub. No.: US 2015/0037657 A1
(43) Pub. Date: Feb. 5, 2015

(54) BATTERY PACK

(71) Applicant: SAMSUNG SDI CO., LTD., Yongin-si (KR)

(72) Inventor: Sunhye HU, Yongin-si (KR)

(73) Assignee: SAMSUNG SDI CO., LTD., Yongin-si (KR)

(21) Appl. No.: 14/085,015

(22) Filed: Nov. 20, 2013

Related U.S. Application Data
(60) Provisional application No. 61/860,543, filed on Jul. 31, 2013.

(51) Int. Cl. H01M 2/20; H01M 2/30

(52) U.S. Cl. CPC H01M 2/202; H01M 2/30; H01M 2/204; H01M 2/206
USPC 429/158; 429/178

(57) ABSTRACT

A battery pack includes conductive tab coupled to the at least one battery cell. The conductive tab has a contact area coupled to a terminal region of the at least one battery cell. The contact area is greater than an area of the terminal region, to support, for example, higher currents and/or over-current conditions. Also, the conductive tab may be secured to the at least one battery cell without the use of specially designed jigs.

### CROSS-REFERENCE TO RELATED APPLICATION

U.S. Provisional Patent Application Ser. No. 61/860,543, filed on Jul. 31, 2013, and entitled “Battery Pack,” is incorporated herein by reference in its entirety.

### BACKGROUND

1. Field

One or more embodiments described herein relate to a battery pack.

2. Description of the Related Art

In general, a battery pack includes a plurality of battery cells, a battery monitoring system board, and a housing accommodating the plurality of battery cells and the battery monitoring system board. The plurality of battery cells are electrically connected to each other by a conductive tab. The conductive tab is electrically connected to the battery monitoring system board through a wire.

### SUMMARY

In accordance with one embodiment, a battery pack includes at least one battery cell and a conductive tab coupled to the at least one battery cell, wherein the at least one battery cell includes a terminal region, and wherein the conductive tab has a contact area coupled to the terminal region of the at least one battery cell, the contact area greater than an area of the terminal region.

Also, the contact area may include a connection region adjacent a first surface which includes the terminal region and, a contacting region adjacent a second surface different from the first surface, wherein the contacting region is coupled to the connection region. The second surface may be a side surface of the at least one battery cell.

Also, the contact area may include a first connection region adjacent a terminal region of a first battery, a first contacting region coupled to the first connection region, a second connection region adjacent a terminal region of a second battery, and a second contacting region coupled to the second connection region, and at least one extension electrically connecting the first connection region to the second connection region, or the first contacting region to the second contacting region.

Also, the at least one extension may be electrically connected to the first connection region to the second connection region. The first connection region, the at least one extension, and the second connection region are integrally formed as one piece. The at least one extension may be electrically connected to the first contacting region to the second contacting region.

Also, the at least one extension may include a first extension electrically connecting the first connection region to the second connection region, and a second extension electrically connecting the first contacting region to the second contacting region, the first extension electrically connected to the second extension.

Also, the battery pack may include a wire coupled to the conductive tab, wherein a first end of the wire is coupled to a surface of the conductive tab and a second end of the wire extends to a position that corresponds to a connection point on a circuit board of a battery monitoring system.

Also, the conductive tab may include an extension, wherein a first end of the extension is electrically coupled to the contact area and a second end of the extension is at a position that corresponds to a connection point on a circuit board of a battery monitoring system.

In accordance with another embodiment, a battery pack includes a plurality of battery cells; a first conductive tab coupled to first and second battery cells; and a second conductive tab electrically coupled to the first conductive tab and a third battery cell, wherein each of the battery cells includes a terminal region and wherein the first conductive tab has a first contact area coupled to terminal regions of the first and second battery cells, and the second conductive tab has a second contact area coupled to a terminal region of the third battery cell, wherein the first contact area is greater than an area of the terminal regions of the first and second battery cells, and wherein the second contact area is greater than an area of the terminal region of the third battery cell.

Also, the first contact area may include a first connection region over the first battery cell, a second connection region over the second battery cell, and a first extension to electrically couple the first and second connection regions. The at least one of the first connection region or the second connection region may have a shape corresponding to a predetermined fraction of a circle. The predetermined fraction may be one of π/4, π/2, or 3π/4.

Also, the first contact area may include a first contacting region coupled to the first connection region, a second contacting region coupled to the second connection region, and a second extension electrically coupled to the first extension, the first contacting region, and the second contacting region. The first contacting region and the second contacting region may have lengths less than half of lengths of the first and second battery cells, respectively.

Also, the first and second connection regions may extend in a first direction, and the first and second contacting regions may extend in a second direction different from the first direction. The first and second conductive tabs may be coupled to different ends of at least one of the first battery cell, the second battery cell, or the third battery cell.

In accordance with another embodiment, a battery pack includes a plurality of battery cells; a plurality of conductive tabs coupled to the battery cells; and a circuit board of a battery monitoring system coupled to the conductive tabs, wherein the conductive tabs include connectors to electrically couple the conductive tabs to the circuit board and wherein the connectors are arranged in a pattern that corresponds to a pattern of connection points on the circuit board, wherein each of the battery cells includes a terminal region, and each of the conductive tabs has a contact area coupled to the terminal region of a respective one of the battery cells, the contact area having an area greater than an area of the terminal region. The connectors may be wires and/or conductive extensions coupled to respective ones of the conductive tabs.

### BRIEF DESCRIPTION OF THE DRAWINGS

Features will become apparent to those of skill in the art by describing in detail exemplary embodiments with reference to the attached drawings in which:

FIGS. 1a, 1b and 1c illustrate one embodiment of a battery pack;

FIGS. 2a to 2c illustrate one embodiment of a conductive tab in a battery pack;

FIGS. 3a to 3c illustrate another embodiment of a conductive tab in a battery pack;

FIGS. 4a to 4c illustrate another embodiment of a conductive tab in a battery pack;

FIGS. 5a to 5c illustrate another embodiment of a conductive tab in a battery pack;

FIGS. 6a to 6e illustrate an embodiment of a method of assembling a battery pack;

FIG. 7 illustrates another embodiment of a battery pack;

FIGS. 8a to 8c illustrate another embodiment of a conductive tab in a battery pack; and

FIGS. 9a to 9c illustrate another embodiment of a conductive tab in a battery pack.

### DETAILED DESCRIPTION

Example embodiments will be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

In addition, the term “conductive tab” used herein means a conductor electrically connected to two battery cells or one battery cell or electrically connecting a battery cell and a battery monitoring system board. Further, the term “conductive tab” used herein means a conductor electrically connected to a battery monitoring system board through a separate wire or directly electrically connected a battery monitoring system board. Additionally, the term “conductive tab” used herein means a conductor coupled to an entire circumference of a cylindrical battery cell or to a partial circumference (arc) of the battery.

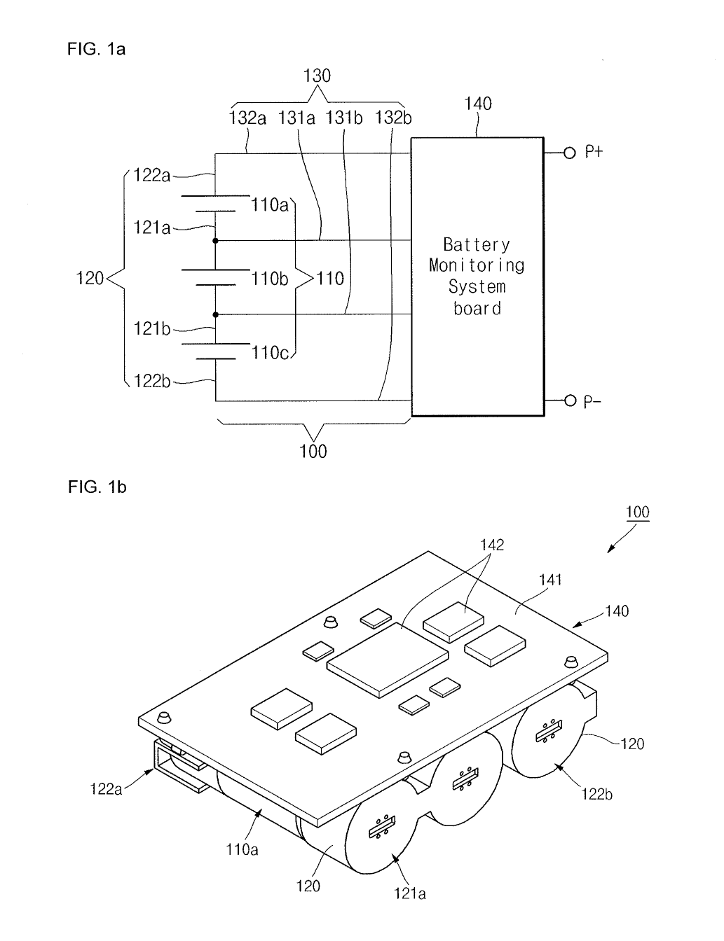

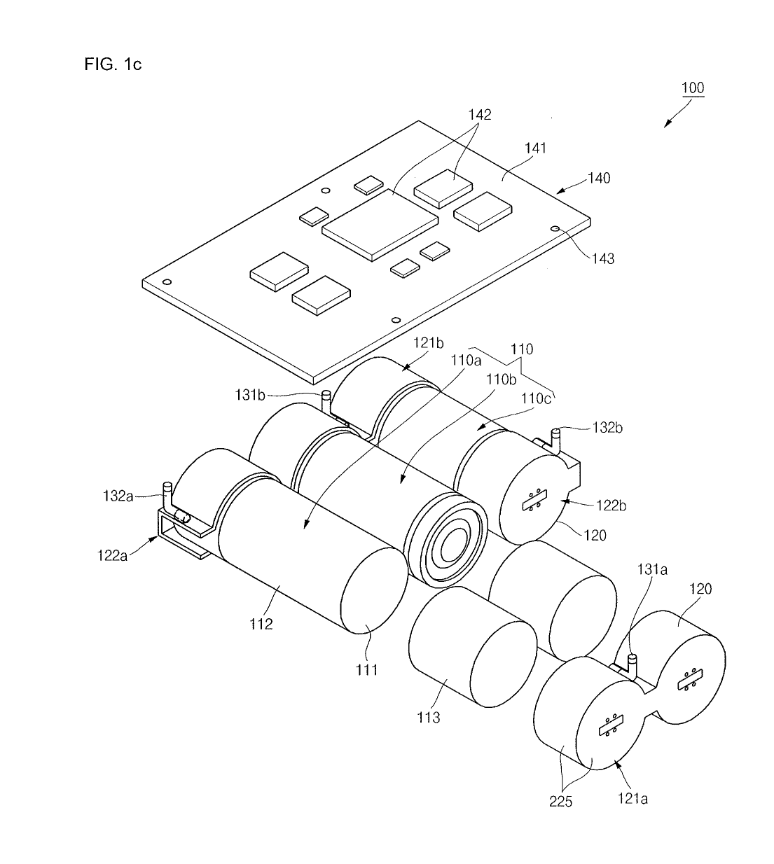

FIGS. 1a, 1b and 1c are a circuit view, a perspective view and a partly exploded perspective view of an embodiment of a battery pack. As illustrated in FIGS. 1a, 1b and 1c, the battery pack 100 includes a battery cell 110, a conductive tab 120 electrically connected to the battery cell 110, a connector electrically connected to the conductive tab 120, and a battery monitoring system board 140 electrically connected to the connector. In this embodiment, the connector may be a wire 130. However, as will be discussed in greater detail below, the connector may be an extension of the conductive tab, for example, adapted to be connected to a circuit board of a battery monitoring system without the use of wires. The battery pack 100 may further include a housing (or a case) accommodating the battery cell 110, the conductive tab 120, the wire 130, and the battery monitoring system board 140.

The battery cell 110 includes a terminal region 111 and a terminal support region 112 extending from the terminal region 111 in a substantially vertical direction.

The terminal region 111 may be roughly disk-shaped and the terminal support region 112 may be shaped of a cylinder extending from the terminal region 111 in a substantially vertical direction. That is to say, the battery cell 110 is generally cylindrical. However, the shape of the battery cell may be different in other embodiments. For example, the battery cell may have a prismatic battery cell or a pouch-type battery cell.

An insulating thermally shrinkable tube may be coupled to the whole terminal support region 112 in at least one embodiment. Also, an insulation member 113 in a shape of a hollow cylinder may be coupled to a partial region of a surface of the terminal support region 112. Therefore, the terminal region 111 of the battery cell 110 may be exposed through the insulating thermally shrinkable tube and the insulation member 113. When the conductive tab 120 is coupled to the terminal region 111 and the terminal support region 112, the conductive tab 120 may therefore be directly electrically connected to only the terminal region 111.

The terminal region 111 may be a positive electrode terminal or a negative electrode terminal. If the terminal region 111 of one side is a positive electrode terminal, the terminal region of the other side is a negative electrode terminal, and vice versa.

In the illustrated embodiment, three battery cells 110 are shown to be connected in series. However, in other embodiment, the three battery cells 110 may be connected in parallel. Also, while three battery cells are shown to be included in the battery pack, in other embodiments fewer or more than three battery cells may be included in the pack.

Each battery cell 110 may be one selected from the group consisting of a lithium ion battery, a lithium polymer battery, a lithium iron phosphate battery, a nickel cadmium battery, a nickel manganese hydrogen battery, and equivalents thereof. In other embodiments, different types of cells may be connected to one another and/or the battery cell may be a different type of battery cell than those listed above.

The conductive tab 120 is electrically connected to the battery cell 110. The conductive tab 120 includes first conductive tabs 121a and 121b electrically connected to two battery cells 110, and second conductive tabs 122a and 122b electrically connected to one battery cell 110. As illustrated in FIG. 1b, when three battery cells 110 are connected in series, two first conductive tabs 121a and 121b and two second conductive tabs 122a and 122b may be provided.

As previously indicated, the battery cell 110 may include a first battery cell 110a, a second battery cell 110b, and a third battery cell 110c. In addition, first conductive tabs 121a and 121b may include a first first conductive tab 121a and a second first conductive tab 121b. The second conductive tabs 122a and 122b may include a first second conductive tab 122a and a second second conductive tab 122b.

The first first conductive tab 121a electrically connects the terminal region 111 of the first battery cell 110a (e.g., a negative electrode terminal) to the terminal region 111 of the second battery cell 110b (e.g., a positive electrode terminal). The second first conductive tab 121b electrically connects the terminal region 111 of the second battery cell 110b (e.g., a negative electrode terminal) to the terminal region 111 of the third battery cell 110c (e.g., a positive electrode terminal).

The wire 130 electrically connects the battery cell 110 to the battery monitoring system board 140. The wire 130 may include a first first wire 131a and a second first wire 131b and a second first wire 132a and a second second wire 132b.

The first first wire 131a electrically connects the first first conductive tab 121a to the battery monitoring system board 140. The second first wire 131b electrically connects the second first conductive tab 121b to the battery monitoring system board 140. The first first wire 131a is a wire for sensing a voltage of the second battery cell 110b, and the second first wire 131b is a wire for sensing a voltage of the third battery cell 110c.

The first second wire 132a electrically connects the first second conductive tab 122a, that is, the terminal region 111 of the first battery cell 110a (e.g., a positive electrode terminal), to the battery monitoring system board 140. The second second wire 132b electrically connects the second second conductive tab 122b, that is, the terminal region 111 of the third battery cell 110c (e.g., a negative electrode terminal), to the battery monitoring system board 140.

In one embodiment, the first second wire 132a and the second second wire 132b correspond to high current paths or over-current paths through which charge current and discharge current of the battery pack 100 may flow. Additionally, or alternatively, the first second wire 132a and the second second wire 132b may allow the battery monitoring system board 140 to sense the overall voltage of the battery pack 100. The first second wire 132a may also serve as a sensing wire for sensing a voltage of the first battery cell 110a. In addition, the second second wire 132b may serve as a sensing wire for sensing a ground voltage of the battery pack 100.

The battery monitoring system board 140 may be coupled to (e.g., mounted on) the plurality of battery cells 110 with an insulation member disposed therebetween. The battery monitoring system board 140 may monitor the voltages, currents, and/or temperatures of the battery cells 110. To this end, the battery monitoring system board 140 includes a plurality of electric/electronic devices 142 mounted on a printed circuit board 141. In addition, a plurality of conductive vias 143 are formed in the printed circuit board 141. The wire 130 may be inserted into and soldered to the conductive vias 143.

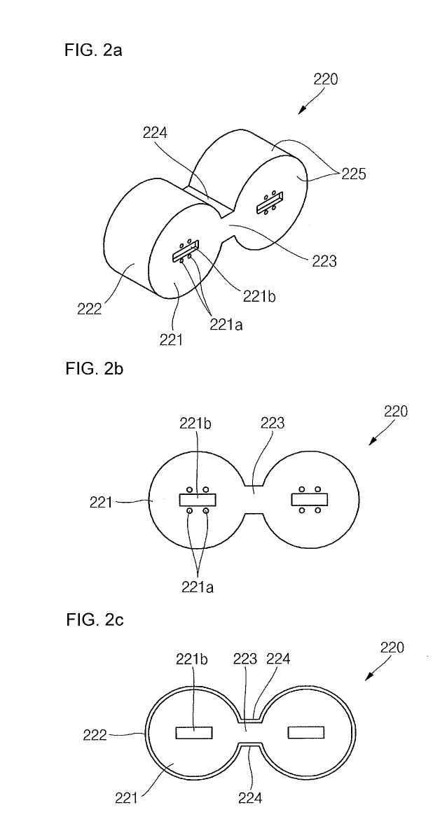

FIGS. 2a to 2c are a perspective view, a front view and a rear view illustrating one embodiment of a conductive tab in a battery pack. This embodiment may be substantially the same as the conductive tab illustrated in FIGS. 1a to 1c.

As illustrated in FIGS. 2a to 2c, the conductive tab 220 includes a contact area 225 including a connection region 221 and a contacting region 222, a first extension region 223, and a second extension region 224. The connection region is to be electrically connected to a terminal region 111 of a battery cell 110. The contacting region 222 extends from the connection region 221 in a substantially vertical direction and closely contacts the terminal support region 112 of the battery cell 110. The connection region 221 and the contacting region 222 may be integrally formed or, for example, welded to one another. The first extension region 223 outwardly extends from the connection region 221. The second extension region 224 extends from the first extension region 223 and the contacting region 222.

The conductive tab 220 connects two battery cells 110 to each other in parallel or in series. In this embodiment, the connection regions 221 and the contacting regions 222 for the two battery cells are symmetrically formed at opposite sides of the first and second extension regions 223 and 224. That is to say, the connection region 221 and the contacting region 222 for each battery cell of the conductive tab 220 are formed at opposite sides of the first and second extension regions 223 and 224.

The conductive tab 220 may be made of one selected from the group consisting of aluminum, an aluminum alloy, copper, a copper alloy, nickel, a nickel alloy, iron, an iron alloy, and equivalents thereof. In other embodiments, the conductive tab may be formed from a different material.

Each connection region 221 of the conductive tab 220 is substantially disk-shaped, to conform to the shape of the terminal region 111 of the battery cell 110. However, a diameter of the connection region 221 is slightly larger than a diameter of the terminal region 111. In addition, a plurality of welding regions 221a electrically welded to the terminal region 111 of the battery cell 110 may be provided in the connection region 221. In addition, one or more through-holes 221b for distributing welding current, without being concentrated during the electrically welding of the plurality of welding regions, may be provided in the connection region 221.

The contacting region 222 of the conductive tab 220 is substantially cylindrical, to conform to the shape of the terminal support region 112 of the battery cell 110. However, a diameter of the contacting region 222 is slightly larger than a diameter of the terminal support region 112. In addition, because the contacting region 222 closely contacts the insulation member 113 surrounding the terminal support region 112 of the battery cell 110, it is not electrically connected to the terminal support region 112 of the battery cell 110. Therefore, the positive and negative electrode terminals of the same battery cell 110 are not simultaneously short-circuited by the contacting region 222 of the conductive tab 220.

Because the contacting region 222 is formed to extend from the connection region 221, the contacting region 222 may increase the overall area of the conductive tab 220, thereby allowing relatively high current and/or over-current to flow. Therefore, according to one embodiment, the conductive tab 220 is suitably used for large-capacity, high-performance battery pack. In addition, the contacting region 222 allows the conductive tab 220 to be stably mounted in the terminal region 111 and the terminal support region 112 of the battery cell 110 with the connection region 221 during welding of the conductive tab 220. As a result, a separate jig for mounting the conductive tab 220 and/or a separate jig for connecting the conductive tab 220 are not required.

In one embodiment, a length of the contacting region 222 is less than half the overall length of the battery cell 110 (e.g., the overall length of the terminal support region 112). As a result, one-side conductive tab 220 coupled to the terminal region 111 of one side, and the conductive tab 220 coupled on the other side to the terminal region 111 of the other side, may not be electrically short-circuited. In other embodiments, the contacting region may have a different length.

The first extension region 223 may have a shape of a flat plate extending in a substantially horizontal direction and outwardly from the connection region 221. A width of the first extension region 223 may be equal to or smaller than a diameter of the connection region 221. In the illustrated embodiment, the width of the first extension region 223 is smaller than the diameter of the connection region 221, but these widths and diameters may be different in other embodiments.

The second extension region 224 is shaped of a flat plate extending in a substantially vertical direction and outwardly from the first extension region 223. In one embodiment, the second extension region 224 has a shape of a flat plate outwardly extending from both the contacting region 222 and the first extension region 223. A width of the second extension region 224 may be equal to or smaller than a diameter of the contacting region 222. In addition, the second extension region 224 may be formed at opposite sides (for example, at upper and lower sides) of the first extension region 223. Further, the second extension region 224 may be interposed between two battery cells 110.

In such a manner, the overall width of the first and second extension regions 223 and 224, in which current flows from one battery cell 110 to another battery cell 110, may be equal to or smaller than the overall width of the connection region 221 and the contacting region 222. Accordingly, even if relatively high current and/or over-current flows through the first and second extension regions 223 and 224, the first and second extension regions 223 and 224 may not be melted or broken.

As described above, the conductive tab 220 according to one embodiment has a larger area than the terminal region 111 of the battery cell 110. As a result, the conductive tab 220 may be suitably used for large-capacity, high-performance battery pack. In addition, because the conductive tab 220 can be stably mounted in the battery cell 110 in a self-aligned manner, a separate jig for mounting and welding the conductive tab 220 is not required, thereby facilitating mounting and welding of the conductive tab 220.

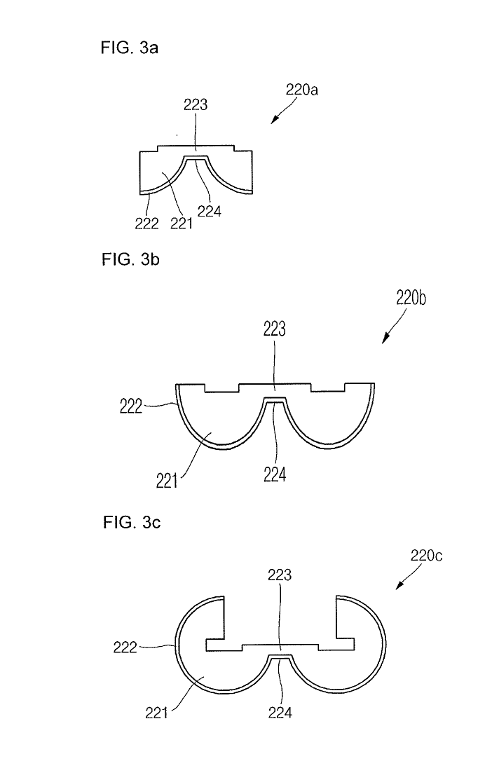

FIGS. 3a to 3c are rear views illustrating another embodiment of a conductive tab in a battery pack. As illustrated in FIG. 3a, a connection region 221 of a conductive tab 220a may have an area of approximately ¼ πr2. As illustrated in FIG. 3b, a connection region 221 of a conductive tab 220b may have an area of approximately ½ π2. As illustrated in FIG. 3c, a connection region 221 of a conductive tab 220c may have an area of approximately ¾ πr2. Here, r is a radius of the connection region. In addition, the connection region 221 of the conductive tab 220 may have various areas. Each of the conductive tabs 220 shown in FIGS. 3a to 3c has a contacting region 222 extending from the connection region 221 in a substantially vertical direction.

Therefore, in the conductive tabs 220a, 220b and 220c, since the connection region 221 is connected to the terminal region 111 of the battery cell 110 and the contacting region 222 closely contacts a terminal support region 112 of the battery cell 110, a current flowing area is increased, and a separate jig for mounting and welding the conductive tab 220 is not required during an assembling process.

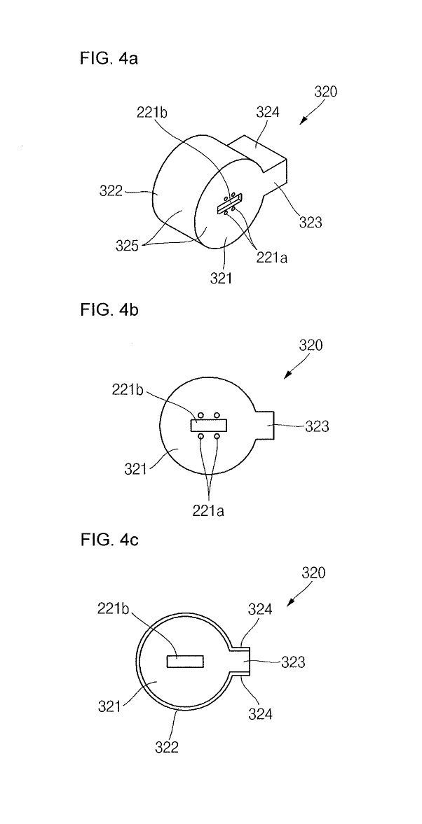

FIGS. 4a to 4c are a perspective view, a front view and a rear view of another embodiment of a conductive tab in a battery pack. As illustrated in FIGS. 4a to 4c, the conductive tab 320 in a battery pack includes a contact area 325 including a connection region 321 and a contacting region 322, a first extension region 323, and a second extension region 324. The connection region 321 electrically connects to a terminal region 111 of a battery cell 110. The contacting region 322 extends from the connection region 321 in a substantially vertical direction and closely contacts a terminal support region 112 of the battery cell 110. The connection region 321 and the contacting region 322 may be integrally formed or, for example, welded to one another. The first extension region 323 outwardly extends from the connection region 321. The second extension region 324 extends from the first extension region 323 and the contacting region 322.

In this embodiment, the conductive tab 320 is electrically connected to one battery cell 110. That is to say, unlike the conductive tab 220 shown in FIGS. 2a to 2c, the conductive tab 320 shown in FIGS. 4a to 4c includes only one connection region 321 and only one contacting region 322 formed at one side of the first and second extension regions 223 and 224. That is, the conductive tab 320 shown in FIGS. 4a to 4c is similar to the conductive tab 220 shown in FIGS. 2a to 2c in view of structure and material, except that the conductive tab 320 shown in FIGS. 4a to 4c has only one connection region 321 and only one contacting region 322.

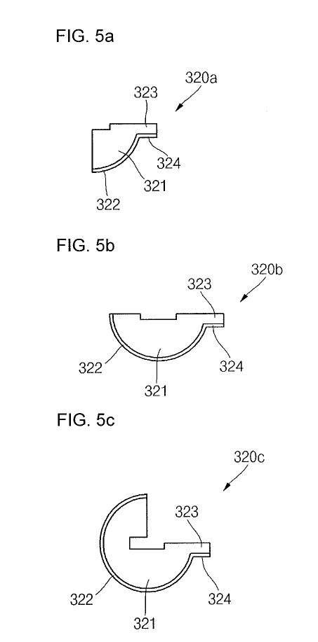

FIGS. 5a to 5c are rear views of another embodiment of a conductive tab. As illustrated in FIG. 5a, a connection region 321 of a conductive tab 320a may have an area of approximately ¼ πr2. As illustrated in FIG. 5b, a connection region 321 of a conductive tab 320b may have an area of approximately ½ πr2. As illustrated in FIG. 5c, a connection region 321 of a conductive tab 320c may have an area of approximately ¾ πr2. Like in the previous embodiment, the conductive tabs 320a, 320b and 320c shown in FIGS. 5a to 5c similar to the conductive tabs 220a, 220b and 220c shown in FIGS. 4a to 4c in view of structure and material, except that each of the conductive tabs 320a, 320b and 320c has only one connection region 321 and only one contacting region 322, and additional explanations will be omitted.

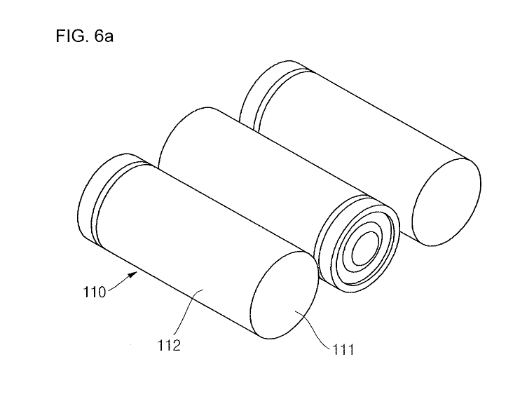

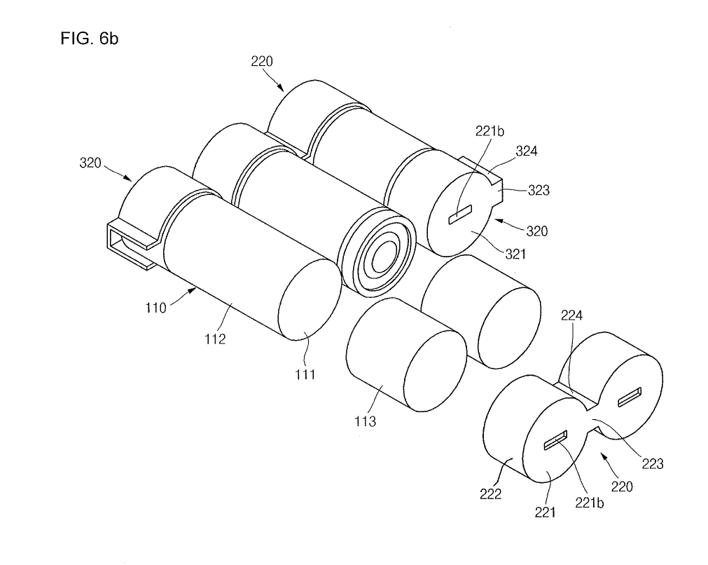

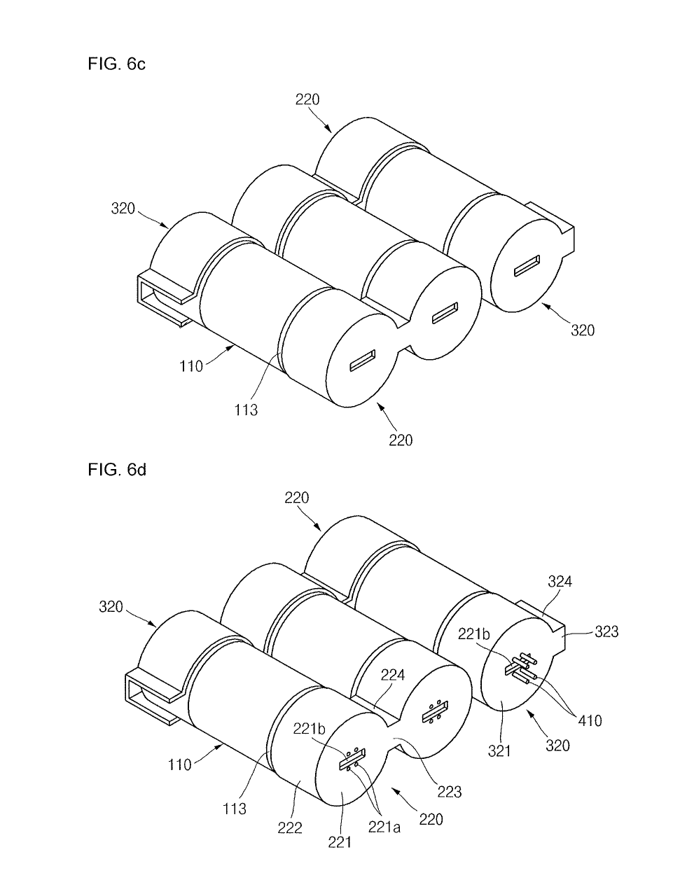

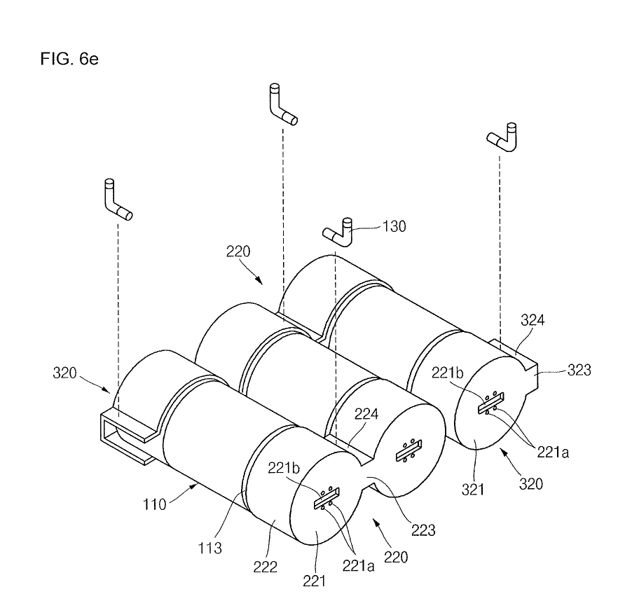

FIGS. 6a to 6e are perspective views illustrating an embodiment of a method of assembling a battery pack. As illustrated in FIG. 6a, a plurality of battery cells 110 are arranged in a predetermined pattern. In one embodiment, the battery cells 110 are arranged in a line. In another embodiment, the battery cells may be arranged in a matrix or other two-dimensional pattern. The latter arrangement may be appropriate when, for example, a larger number of battery cells are included in the pack.

As illustrated in FIG. 6a, each battery cell 110 may include a substantially disk-shaped terminal region 111 and a substantially cylindrical terminal support region 112 extending from the terminal region 11 in a vertical or other direction are arranged in a line. Here, the terminal region 111 may be a positive electrode terminal or a negative electrode terminal.

As illustrated in FIGS. 6b and 6c, an insulation member 113 is coupled to a terminal support region 112 of the battery cell 110. The insulation member may be in the form of a sleeve having, for example, a cylindrical shape and/or a shape that conforms to the shape of a battery cell. In one embodiment, only the terminal region 111 is exposed to the outside. The conductive tab 220 including a connection region 221, a contacting region 222, and first and second extension regions 223 and 224 are coupled to the battery cell 110. That is to say, the connection region 221 of the conductive tab 220 is made to contact the terminal region 111 of the battery cell 110, and the contacting region 222 of the conductive tab 220 is made to closely contact the terminal support region 112 of the battery cell 110.

In addition, symmetrically formed conductive tabs 220 are coupled to two battery cells 110 connected in series or in parallel, and an asymmetrically formed conductive tab 320 is coupled to the battery cells 110.

As illustrated in FIG. 6d, conductive tabs 220 and 320 are electrically connected to the battery cell 110, for example, by welding tools 410. For exmaple, the welding tools 410 may be set relative to through-holes 221b provided in the connection regions 221 and 321 of the conductive tabs 220 and 320. Then, welding current may be applied to the welding tools 410, thereby forming a plurality of welding regions 221a at opposite positions of the through-holes 221b provided in the conductive tabs 220 and 320. Here through-holes 221b serve to distribute welding current, thereby preventing the conductive tabs 220 and 320 or the battery cell 110 from being damaged.

As illustrated in FIG. 6e, one end of some of a plurality of wires 130 is welded (or otherwise coupled) to a respective one of the second extension regions 224 and 324 provided in the conductive tabs 220 and 320. An end of other wires 130 may be welded to respective connection regions 221 and 321, the contacting regions 222 and 322, or the first extension regions 223 and 323 provided in the conductive tabs 220 and 320.

Each wire 130 may then be electrically connected to the battery monitoring system board 140. In an exemplary embodiment, each wire 130 may be coupled to a respective conductive via 143 (or connection point) in the battery monitoring system board 140 and then soldered.

Through this embodiment, the conductive tab may be stably mounted in the battery cell in a self-aligned manner. As a result, a separate jig for mounting and welding the conductive tab is not required, thereby improving the efficiency of connecting the conductive tabs in the battery pack.

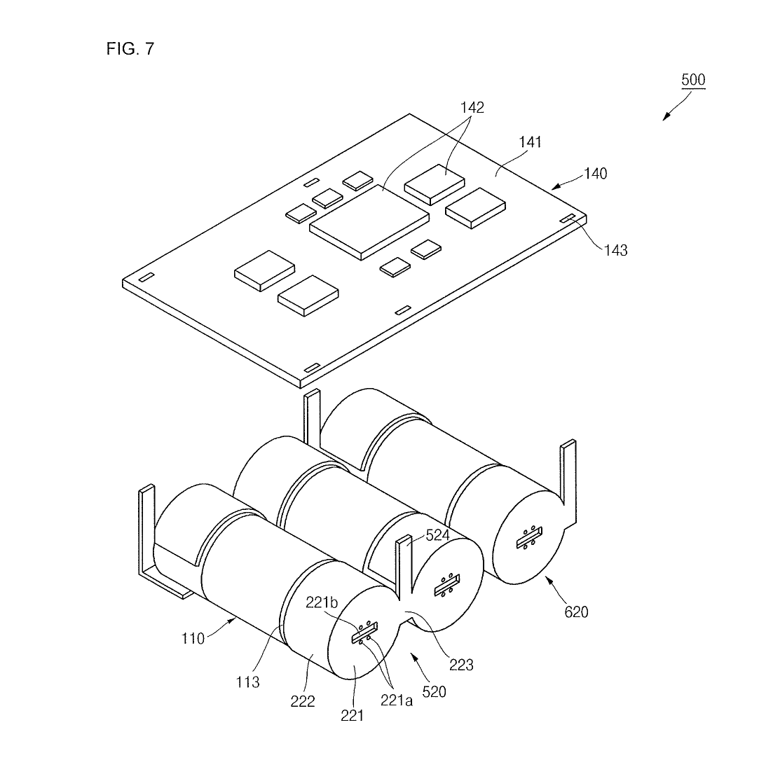

FIG. 7 illustrates another embodiment of a battery pack 500, which includes a conductive tab 520 directly electrically connected to a battery monitoring system board 140 without a separate wire. The conductive tab 520 may include at least one second extension region 524 separated from a contacting region 222 and outwardly extending in a direction substantially parallel to a first extension region 223.

More specifically, at least one second extension region 524 exists at upper, side, and/or lower portions of the first extension region 223. For example, the upper second extension region 524 may be separated from the contacting region 222 and may upwardly extend. While the second extension region 524 is shown to be substantially parallel to the first extension region 223, in other embodiments the second extension region 524 may extend at various angles with respect to the first extension region 223, according to, for example, positions of the conductive vias 143 formed in the battery monitoring system board 140. In some cases, the second extension region 524 may be bent at various angles from a predetermined position.

The conductive vias 143 are formed in the battery monitoring system board 140 corresponding to the second extension region 524. Each second extension region 524 may be coupled to a respective one of the conductive vias 143 and then soldered.

Therefore, in battery pack 500, the conductive tab 520 is directly electrically connected to the battery monitoring system board 140 without a separate wire, thereby simplifying the process of establishing electrical connection between the battery cells 110 and the battery monitoring system board 140. In addition, because no additional wires are provided between the conductive tab 520 and the battery monitoring system board 140, the electrical resistance therebetween is small, thereby minimizing an area where heat is generated when high current and/or over-current flows between the battery cell and the battery monitoring system board.

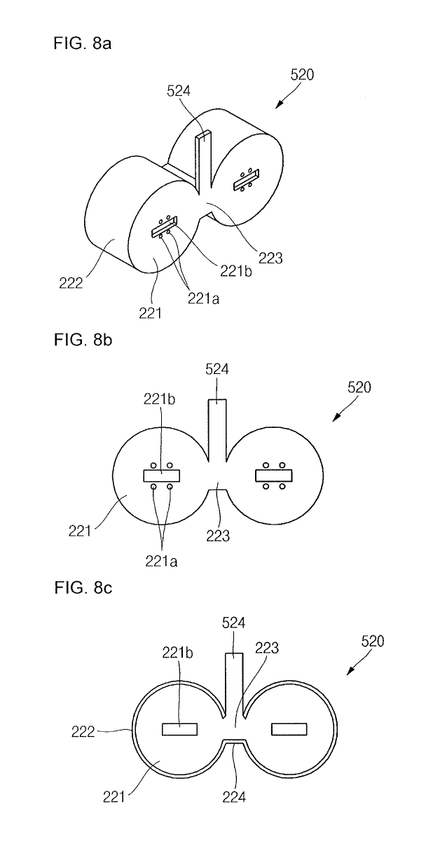

FIGS. 8a to 8c are a perspective view, a front view and a rear view illustrating another embodiment of a conductive tab in a battery pack. As illustrated in FIGS. 8a to 8c, a conductive tab 520 is used in electrically connecting two battery cells 110. As described above, second extension regions may be formed at upper, side, and/or lower portions of a first extension region 223, and the upper second extension region 524 may be separated from contacting regions 222 and may outwardly extend. That is to say, the second extension region 524 may upwardly extend and be substantially parallel to the first extension region 223. In one embodiment the second extension regions 524 may be integrally formed with the first extension regions, and surfaces of the first and second extension regions may be coplanar, so as to form one continuous surface.

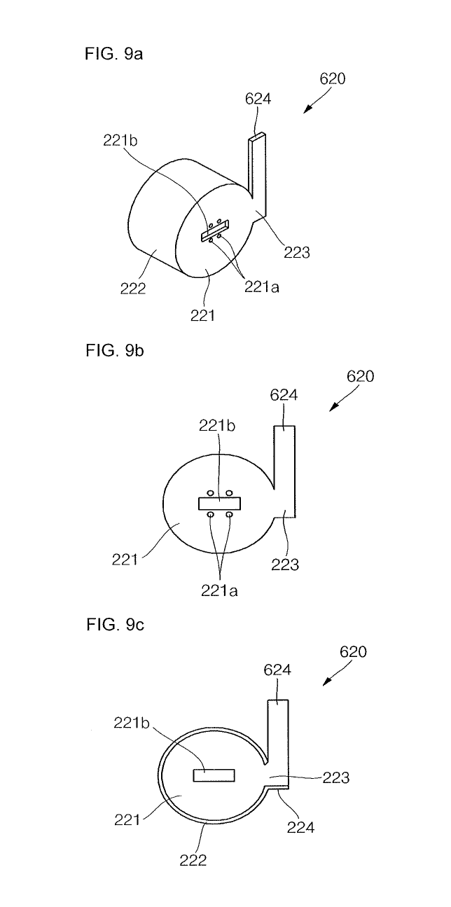

FIGS. 9a to 9c are a perspective view, a front view and a rear view illustrating another embodiment of a conductive tab in a battery pack. As illustrated in FIGS. 9a to 9c, a conductive tab 620 is electrically connected to one battery cell 110. As described above, in view of a first extension region 223, an upper second extension region 624 is separated from one contacting region 222 and may upwardly extend. In addition, the second extension region 624 may be integrally formed and substantially parallel to the first extension region 223. In other embodiments, the first and second extension regions may be connected, but not integrally formed with one another.

In addition, the conductive tab 520 shown in FIGS. 8a to 8c and the conductive tab 620 shown in FIGS. 9a to 9c may include a connection region having an area of approximately ¼ πr2 to ¾ πr2, like the conductive tab shown in FIGS. 3a to 3c and/or the conductive tab shown in FIGS. 5a to 5c.

By way of summation and review, one or more embodiments include a battery pack with a conductive tab electrically connected to one or more battery cells. The conductive tab has a contact area coupled to a terminal region, the contact area being greater than an area of the terminal region. The conductive tab maybe cup-shaped to have a larger surface area adapted to fit onto the one or more battery cells. With such a structure, the conductive tab demonstrates an improved resistance to melting and/or breaking, even in the case of a high current and/or over-current flows. The battery pack, therefore, may be suitable for achieving large-capacity and high-performance.

In contrast, conductive tabs were generally designed to have smaller area and/or thickness than a diameter and/or thickness of a battery cell, the conductive tab may melt when used with higher current levels. Also, when an over current exists, the conductive tab may be easily broken.

In addition, one or more embodiments include a battery pack with a conductive tab which is adapted to be mounted on one or more battery cells in a self-aligned manner. The conductive tab has a contact area coupled to a terminal region, the contact area being greater than an area of the terminal region. The conductive tab maybe cup-shaped to have a larger surface area adapted to fit onto the one or more battery cells. As a result, a separate jig for mounting and welding the conductive tab is not required, thereby providing the battery pack capable of facilitating mounting and welding of the conductive tab, as using specially designed jigs to connect a conductive tab to a battery cell makes the connecting process time consuming and complicated.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims

What is claimed is:

1. A battery pack, comprising:
at least one battery cell; and
a conductive tab coupled to the at least one battery cell,
wherein the at least one battery cell includes a terminal region, and
wherein the conductive tab has a contact area coupled to the terminal region of the at least one battery cell, the contact area greater than an area of the terminal region.

2. The battery pack of claim 1, wherein the contact area includes:
a connection region adjacent a first surface which includes the terminal region and,
a contacting region adjacent a second surface different from the first surface, wherein the contacting region is coupled to the connection region.

3. The battery pack of claim 2, wherein the second surface is a side surface of the at least one battery cell.

4. The battery pack of claim 1, wherein the contact area includes:
a first connection region adjacent a terminal region of a first battery,
a first contacting region coupled to the first connection region,
a second connection region adjacent a terminal region of a second battery, and
a second contacting region coupled to the second connection region, and
at least one extension electrically connecting the first connection region to the second connection region, or the first contacting region to the second contacting region.

5. The battery pack of claim 4, wherein the at least one extension electrically connects the first connection region to the second connection region.

6. The battery pack of claim 5, wherein the first connection region, the at least one extension, and the second connection region are integrally formed as one piece.

7. The battery pack of claim 4, wherein the at least one extension electrically connects the first contacting region to the second contacting region.

8. The battery pack of claim 5, wherein the at least one extension includes:
a first extension electrically connecting the first connection region to the second connection region, and
a second extension electrically connecting the first contacting region to the second contacting region, the first extension electrically connected to the second extension.

9. The battery pack of claim 1, further comprising:
a wire coupled to the conductive tab,
wherein a first end of the wire is coupled to a surface of the conductive tab and a second end of the wire extends to a position that corresponds to a connection point on a circuit board of a battery monitoring system.

10. The battery pack of claim 1, wherein the conductive tab includes:
an extension region,
wherein a first end of the extension region is electrically coupled to the contact area and a second end of the extension is at a position that corresponds to a connection point on a circuit board of a battery monitoring system.

11. A battery pack, comprising:
a plurality of battery cells;
a first conductive tab coupled to first and second battery cells; and
a second conductive tab electrically coupled to the first conductive tab and a third battery cell, wherein each of the battery cells includes a terminal region and wherein:
the first conductive tab has a first contact area coupled to terminal regions of the first and second battery cells, and
the second conductive tab has a second contact area coupled to a terminal region of the third battery cell, wherein the first contact area is greater than an area of the terminal regions of the first and second battery cells, and wherein the second contact area is greater than an area of the terminal region of the third battery cell.

12. The battery pack of claim 11, wherein the first contact area includes:
a first connection region over the first battery cell,
a second connection region over the second battery cell, and
a first extension to electrically couple the first and second connection regions.

13. The battery pack of claim 12, wherein at least one of the first connection region or the second connection region has a shape corresponding to a predetermined fraction of a circle.

14. The battery pack of claim 13, wherein the predetermined fraction is one of π/4, π/2, or π/4.

15. The battery pack of claim 12, wherein the first contact area includes:
a first contacting region coupled to the first connection region,
a second contacting region coupled to the second connection region, and
a second extension electrically coupled to the first extension, the first contacting region, and the second contacting region.

16. The battery pack of claim 15, wherein the first contacting region and the second contacting region have lengths less than half of lengths of the first and second battery cells, respectively.

17. The battery pack of claim 15, wherein:
the first and second connection regions extend in a first direction, and
the first and second contacting regions extend in a second direction different from the first direction.

18. The battery pack of claim 11, wherein the first and second conductive tabs are coupled to different ends of at least one of the first battery cell, the second battery cell, or the third battery cell.

19. A battery pack, comprising:
a plurality of battery cells;
a plurality of conductive tabs coupled to the battery cells; and
a circuit board of a battery monitoring system coupled to the conductive tabs, wherein the conductive tabs include connectors to electrically couple the conductive tabs to the circuit board and wherein the connectors are arranged in a pattern that corresponds to a pattern of connection points on the circuit board, wherein:
each of the battery cells includes a terminal region, and
each of the conductive tabs has a contact area coupled to the terminal region of a respective one of the battery cells, the contact area having an area greater than an area of the terminal region.

20. The battery pack of claim 19, wherein:
the connectors are wires, or
the connectors are conductive extensions coupled to respective ones of the conductive tabs.
